(19) United States
(12) Patent Application Publication
(10) Pub. No.: US 2022/0163118 A1
(43) Pub. Date: May 26, 2022

(54) SEAL STACK ASSEMBLY FOR RECIPROCATING PUMP

(71) Applicant: Saint-Gobain Performance Plastics Corporation, Solon, OH (US)

(72) Inventors: Andrea Maffezzoli, Monza (IT); Herman M. Dubois, Duffel (BE); Colby Stark, Costa Mesa, CA (US); Philippe Burlot, Le Quillio (FR); Gino L. Stevenheydens, Willebroek (BE); Christel C. Goy, Anaheim, CA (US); Xiang Yan, Barrington, RI (US)

(21) Appl. No.: 17/456,324

(22) Filed: Nov. 23, 2021

Related U.S. Application Data
(60) Provisional application No. 63/117,806, filed on Nov. 24, 2020.

(51) Int. Cl. F16J 15/3236; F04B 53/16

(52) U.S. Cl. CPC F16J 15/3236; F04B 53/164

(57) ABSTRACT

Systems and methods include providing an annular seal stack for an assembly. The seal stack assembly includes, at least one second annular seal, a spacer disposed axially adjacent to the at least one second annular seal, and a third annular seal disposed axially adjacent to the spacer. The seal stack assembly is disposed between a probe and a housing of the assembly and configured to provide an annular seal between the probe and the housing during operation of the assembly at cryogenic temperatures, during exposure of at least a portion of the seal stack assembly to cryogenic temperatures, during a change in pressure, during a change in temperature, or a combination thereof.

### CROSS-REFERENCE TO RELATED APPLICATION(S)

This application claims priority under 35 U.S.C. § 119(e) to U.S. Provisional Application No. 63/117,806, entitled “SEAL STACK ASSEMBLY FOR RECIPROCATING PUMP,” by Andrea MAFFEZZOLI et al., filed Nov. 24, 2020, which is assigned to the current assignee hereof and incorporated herein by reference in its entirety.

### BACKGROUND OF THE INVENTION

Seals are used in many industrial applications to prevent leakage between components of an assembly. In some applications, seals may be subjected to extreme operating conditions, such as extreme pressures or temperatures. These extreme operating conditions often necessitate the use of a seal stack assembly, which uses a plurality of individual seals, to provide an efficient and reliable seal along long probes or shafts that oscillate, reciprocate, rotate, vibrate, or combinations thereof with respect to a housing. At such extreme operating conditions, such as those present during the use of liquid hydrogen, traditional seal stack assemblies may not effectively maintain a seal. Accordingly, the industry continues to demand improvements in seal technology for such applications.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1A is a partial cross-sectional view of an assembly having an annular seal stack assembly according to an embodiment of the disclosure.

FIG. 1B is a partial cross-sectional view of an assembly having an annular seal stack assembly according to an embodiment of the disclosure.

FIG. 2 is a cross-sectional view of a first annular seal according to an embodiment of the disclosure.

FIG. 3 is a cross-sectional view of a second annular seal according to an embodiment of the disclosure.

FIG. 4 is an oblique view of a spacer according to an embodiment of the disclosure.

FIG. 5 is a cross-sectional view of a third annular seal according to an embodiment of the disclosure.

FIG. 6 is a flowchart of a method of forming an annular seal in an assembly according to an embodiment of the disclosure.

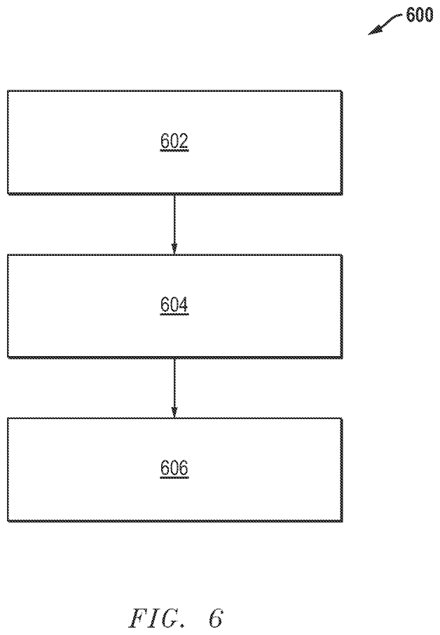

The use of the same reference symbols in different drawings indicates similar or identical items.

### DETAILED DESCRIPTION

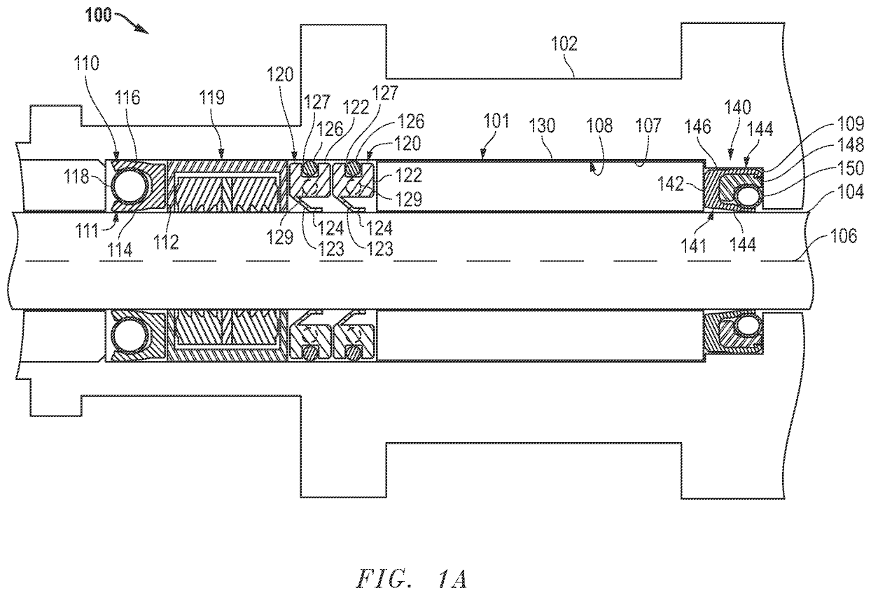

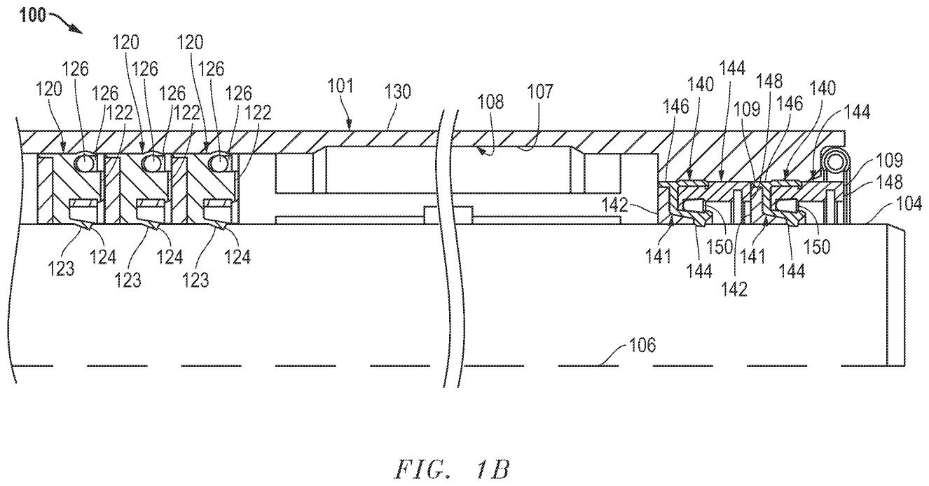

FIG. 1A shows a partial cross-sectional view of an assembly 100 having an annular seal stack assembly 101 according to an embodiment of the disclosure. In some embodiments, the assembly 100 may be a cryogenic reciprocating application. In some embodiments, the assembly 100 may be a coupling assembly, a pump assembly, a solenoid assembly, or valve assembly. In some embodiments, the assembly 100 may be a reciprocating pump assembly. In some embodiments, the assembly 100 may be a cryogenic pump assembly. In a particular embodiment, the assembly 100 may comprise a liquid hydrogen (LH2) reciprocating pump. The assembly 100 may generally comprise a housing 102 and a probe or shaft 104 that oscillates, reciprocates, rotates, vibrates, or combinations thereof with respect to the housing 102. In more specific embodiments, the assembly 100 may comprise a housing 102 and a shaft 104 that reciprocates axially along an axis 106 of the shaft 104. The assembly 100 may further comprise a cavity 108 formed between the housing 102 and the probe 104 and configured to receive the seal stack assembly 101. In some embodiments, the cavity 108 may comprise a first portion 107 and a second portion 109. In some embodiments, the first portion 107 may comprise a larger outer diameter defined by the housing 102 than the second portion 109. In some embodiments, the first portion 107 may comprise a smaller outer diameter defined by the housing 102 than the second portion 109. However, in some embodiments, the first portion 107 and the second portion 109 may comprise a substantially similar or the same outer diameter defined by the housing 102. It will be appreciated that portions of the seal stack assembly 101 may be disposed in each portion 107, 109 of the cavity 108 to form an annular seal between the housing 102 and the shaft 104.

An annular seal stack assembly 101 comprising a first seal 110, at least one second seal 120, a spacer 130, and a third seal 140 may generally be disposed within the cavity 108 of the assembly 100 and annularly about the shaft 104. The seal stack assembly 101 may generally comprise an upper end (first end) defined by the first annular seal 110 and a lower end (opposing second end) defined by the third annular seal 140. The seal stack assembly 101 may generally be configured to contact and provide a radial seal between the housing 102 and the shaft 104 of the assembly 100. In some embodiments, the seal stack assembly 101 may continually provide an annular seal between the housing 102 and the shaft 104 of the assembly 100 during operation of the assembly 100 at cryogenic temperatures, during exposure of at least a portion of the seal stack assembly 101 to cryogenic temperatures, or a combination thereof. In some embodiments, the seal stack assembly 101 may be suitable for operation between room temperature (at least about 15 degrees Celsius) and cryogenic temperatures (at least about −150 degrees Celsius, or even at least −270 degrees Celsius) to continually provide an annular seal between the housing 102 and the shaft 104 of assembly. In some embodiments, the seal stack assembly 101 may also be suitable for operation at elevated pressures (at least up to 24 bar (about 350 psi) or greater) to continually provide an annular seal between the housing 102 and the shaft 104 of assembly 100. In some embodiments, the seal stack assembly 101 may be configured to continually provide the annular seal between the housing 102 and the shaft 104 of the assembly during a change in pressure, a change in temperature, or a combination thereof.

The first annular seal 110 may be configured to contact and provide an annular seal between a portion of the housing 102 and a portion of the shaft 104 of the assembly 100. The first annular seal 110 may generally comprise a jacket 111 comprising a base 112, an inner sealing leg 114 extending from the base 112, and an outer sealing leg 116 extending from the base 112. The first annular seal 110 may also comprise an energizing spring 118 disposed within the jacket 111 between and in contact with the inner sealing leg 114 and the outer sealing leg 116 of the jacket 111. In some embodiments, the energizing spring 118 may be round. However, in other embodiments, the energizing spring 118 may be elliptical, oval, U-shaped, or any other suitable shape. The energizing spring 118 may be configured to bias the inner sealing leg 114 and the outer sealing leg 116 away from each other to maintain contact between the sealing legs 114, 116 of the first annular seal 110 and each of the housing 102 and the shaft 104 of the assembly 100.

In some embodiments, the first annular seal 110 may comprise a scraper 119. However, in some embodiments, the scraper 119 may be a standalone component and may be present in the seal stack assembly 101 without a first annular seal 110. In some embodiments, the scraper 119 may be disposed adjacent to the base of the first annular seal 110. In other embodiments, the scraper 119 may be disposed at the upper end of the seal stack assembly and disposed adjacent to ends of the sealing legs 114, 116 of the jacket 111 of the first annular seal 110. The scraper 119 may be configured to prevent and/or remove an accumulation of moisture, ice, or a combination thereof from the shaft 104 of the assembly 100. It will be appreciated that the first annular seal 110 comprising a scraper 119 may be substantially similar to those disclosed in U.S. Pat. No. 10,626,994 B2, the disclosure of which is incorporated by reference herein.

The first annular seal 110 may be disposed in the first portion 107 of the cavity 108 of the assembly 100. The first annular seal 110 may be disposed at the upper end of the seal stack assembly 101. The first annular seal 110 may generally be oriented in the cavity 108 such that the jacket 111 is open outward towards the upper end of the seal stack assembly 101 and the base 112 of the jacket 111 is oriented inward towards the lower end of the seal stack assembly 101. Additionally, the first annular seal 110 may generally be oriented in the cavity 108 such that the inner sealing leg 114 of the jacket 111 extends along and in contact with the shaft 104 and the outer sealing leg 116 of the jacket 111 extends along and in contact with the housing 102. In some embodiments, the seal stack assembly 101 may comprise a plurality of first annular seals 110. In such embodiments, each of the plurality of first annular seals 110 may be oriented in the same direction as disclosed herein. Further, in embodiments comprising a plurality of first annular seals 110, one or more of the plurality of first annular seals 110 may not comprise a scraper 119. Accordingly, in some embodiments comprising a plurality of first annular seals 110, only one of the first annular seals 110 may comprise a scraper 119, such that the seal stack assembly 101 comprises a single scraper 119. However, in some embodiments comprising a plurality of first annular seals 110, the seal stack assembly 101 may comprise a plurality of scrapers 119.

The second annular seal 120 may be configured to contact and provide an annular seal between a portion of the housing 102 and a portion of the shaft 104 of the assembly 100. The second annular seal 120 may be different from the first annular seal 110. The second annular seal 120 may generally comprise a body 122, an inner sealing leg 123 extending at an angle from the body 122, and a sealing flange 124 extending at an angle from an end of the inner sealing leg 123. The second annular seal 120 may also comprise a sealing ring 126 disposed in a cavity 127 formed in the body 122 and on an opposing side of the body 122 from the sealing leg 123 and the sealing flange 124. In some embodiments, the sealing ring 126 may comprise an O-ring. In some embodiments, the sealing ring 126 may comprise an energizing spring. In some embodiments, the sealing ring 126 may comprise a spring energized seal integrated within the cavity 127. Further, in some embodiments, the second annular seal 120 may also comprise an outer sealing leg on the outer diameter of the second annular seal 120. In particular embodiments, the outer sealing leg may extend from the body 122 and be substantially similar to and/or symmetrical about the body with the sealing leg 123 on the inner diameter of the second annular seal 120. In some embodiments, the body 122 may comprise a substantially rectangular or square profile. In some embodiments, the body 122 may comprise rounded or chamfered corners. In some embodiments, the second annular seal 120 may comprise an energizing spring disposed between the body 122 and the sealing leg 123 and/or the sealing flange 124. In some embodiments, the second annular seal 120 may comprise a metal band 129 disposed throughout the body 122. The metal band 129 may reduce the sensitivity of the second annular seal 120 to thermal contraction.

The second annular seal 120 may be disposed in the first portion 107 of the cavity 108 of the assembly 100. In some embodiments, the second annular seal 120 may be disposed adjacent to the scraper 119. In some embodiments, the second annular seal 120 may be disposed adjacent to the first annular seal 110. In some embodiments, the second annular seal 120 may be disposed between the scraper 119 and the spacer 130. In some embodiments, the second annular seal 120 may be disposed between the first annular seal 110 and the spacer 130. The second annular seal 120 may generally be oriented in the cavity 108 such that the inner sealing leg 123 extends from the body 122 inwardly at an angle towards the shaft 104 and in the direction of the spacer 130. The second annular seal 120 may also be oriented such that the sealing flange 124 is in contact with the shaft 104. In some embodiments, the sealing flange 124 may be substantially flat about the circumference or outer diameter of the shaft 104. However, in other embodiments, the sealing flange 124 may contact the shaft 104 at an angle. The second annular seal 120 may also be oriented such that the sealing ring 126 is in contact with and forms an annular seal with the housing 102. In some embodiments, the seal stack assembly 101 may comprise a plurality of second annular seals 120. In some embodiments, the seal stack assembly 101 may comprise two second annular seals 120. In some embodiments, the seal stack assembly 101 may comprise more than two second annular seals 120. In such embodiments, the plurality of second annular seals 120 may be oriented in the same direction as disclosed herein. In embodiments comprising a plurality of second annular seals 120, one or more of the second annular seals 120 may be free of the sealing ring 126. Further, in some embodiments, the seal stack assembly 101 may not comprise a first annular seal 110, such that the second annular seal 120 and/or a scraper 119 defines the upper end of the seal stack assembly 101.

The spacer 130 may be configured to cooperate with and/or support the first annular seal 110, the at least one second annular seal 120, and the third annular seal 140 to maintain an annular seal between the housing 102 and the shaft 104 of the assembly 100. In some embodiments, the spacer 130 may comprise a rigid hollow component having a substantially uniform inner diameter and a substantially uniform outer diameter. In some embodiments, the spacer 130 may also distribute forces acting on one or more of the annular seals 110, 120, 140 to other annular seals 110, 120, 140 in the seal stack assembly 101 to maintain a pressure distribution across the seal stack assembly 101. Furthermore, in alternative embodiments, the spacer 130 may comprise a plurality of annular seals (e.g., seals 110, 120, 140, or any other suitable annular seal) or other annular components configured to fill the length of the seal stack assembly 101 along the axial length of the shaft 104 of the assembly.

The spacer 130 may be disposed in the first portion 107 of the cavity 108 of the assembly 100. In some embodiments, the spacer 130 may comprise a clearance fit within the first portion 107 of the cavity 108 of the assembly 100. In some embodiments, the spacer 130 may comprise a tight-tolerance clearance fit within the first portion 107 of the cavity 108 of the assembly 100. The spacer 130 may be disposed adjacent to the second annular seal 120. The spacer 130 may be disposed between the second annular seal 120 and the third annular seal 140. In some embodiments, the spacer 130 may be a single unitary component. In some embodiments, the seal stack assembly 101 may comprise a plurality of spacers 130. In such embodiments, an O-ring or other sealing mechanism may be disposed between adjacent spacers 130. In alternative embodiments, the spacer 130 may comprise any other profile configured to occupy a length along the shaft 104 of the assembly 100.

In some embodiments, the spacer 130 may comprise a length that is axially longer than the first annular seal 110, the second annular seal 120, the third annular seal 140, and/or the total length of any combination thereof. In some embodiments, the spacer 130 may comprise a majority of the total axial length of the seal stack assembly 101. In some embodiments, the spacer 130 may comprise at least 25%, at least 30%, at least 35%, at least 40%, at least 45%, at least 50%, at least 60%, at least 65%, or at least 75% of the total axial length of the seal stack assembly 101. In some embodiments, the spacer 130 may comprise not greater than 95%, not greater than 90%, not greater than 85%, not greater than 80%, not greater than 75%, not greater than 70%, not greater than 65%, or not greater than 60% of the total axial length of the seal stack assembly 101. Further, the spacer 130 may comprise between any of these minimum and maximum values of the total axial length of the seal stack assembly 101, such as at least 25% to not greater than 95%, or even at least 50% to not greater than 75% of the total axial length of the seal stack assembly 101.

The third annular seal 140 may be configured to contact and provide an annular seal between a portion of the housing 102 and a portion of the shaft 104 of the assembly 100. The third annular seal 140 may be different from the first annular seal 110. The third annular seal 140 may be different from the second annular seal 120. The third annular seal 140 may generally comprise a jacket 141 comprising a base 142, an inner sealing leg 144 extending from the base 142, and an outer sealing leg 146 extending from the base 142. The third annular seal 140 may also comprise a support ring 148 disposed within the jacket 141. In some embodiments, the support ring 148 may comprise a substantially L-shaped component, a substantially U-shaped component, a substantially rectangular component, or any other suitable shape. In some embodiments, the support ring 148 may be disposed in the jacket 141 such that the support ring 148 is in contact with the outer sealing leg 146 of the jacket 141. In some embodiments, the support ring 148 may be disposed in the jacket 141 such that the support ring 148 is in contact with the base 142 and the outer sealing leg 146 of the jacket 141. In other embodiments, the support ring 148 may be disposed in the jacket 141 such that the support ring 148 is in contact with the base 142, the inner sealing leg 144 of the jacket 141, and the outer sealing leg 146 of the jacket 141.

In some embodiments, the support ring 148 may provide additional support to the third annular seal 140 as compared to the first annular seal 110 and the second annular seal 120. In some embodiments, the support ring 148 may enable the third annular seal 140 to withstand more extreme temperatures and/or pressures as compared to the first annular seal 110 and the second annular seal 120. The third annular seal 140 may also comprise an energizing spring 150. The energizing spring 150 may be disposed within the jacket 141 between and in contact with the inner sealing leg 144 of the jacket 141 and the support ring 148. In some embodiments, the energizing spring 150 may be elliptical or oval. However, in other embodiments, the energizing spring 150 may be round, U-shaped, or any other shape. The energizing spring 150 may be configured to bias the inner sealing leg 144 and the outer sealing leg 146 away from each other to maintain contact between the sealing legs 144, 146 of the third annular seal 140 and each of the housing 102 and the shaft 104 of the assembly 100.

The third annular seal 140 may be disposed in the second portion 109 of the cavity 108 of the assembly 100. In some embodiments, the third annular seal 140 may comprise a smaller outer diameter than an outer diameter of the first annular seal 110, the second annular seal 120, and/or the spacer 130. In some embodiments, the third annular seal 140 may comprise a larger outer diameter than the outer diameter of the first annular seal 110, the second annular seal 120, and/or the spacer 130. In some embodiments, the third annular seal 140 may comprise a substantially similar or the same outer diameter as the outer diameter of the first annular seal 110, the second annular seal 120, and/or the spacer 130. It will be appreciated that the outer diameter of the third annular seal 140 may be based on the outer diameter of the second portion 109 of the cavity 108.

In some embodiments, the outer diameter of the third annular seal 140 may be at least 1%, at least 2%, at least 3%, at least 4%, at least 5%, at least 10%, at least 15%, at least 20%, or at least 25% smaller or larger than the outer diameter of the first annular seal 110, the second annular seal 120, and/or the spacer 130. In some embodiments, the outer diameter of the third annular seal 140 may be not greater than 50%, not greater than 45%, not greater than 40%, not greater than 35%, not greater than 30%, or not greater than 25% smaller or larger than the outer diameter of the first annular seal 110, the second annular seal 120, and/or the spacer 130. Further, the outer diameter of the third annular seal 140 may be between any of these minimum and maximum values, such as at least 1% to not greater than 50%, or even at least 10% to not greater than 25% smaller or larger than the outer diameter of the first annular seal 110, the second annular seal 120, and/or the spacer 130.

The third annular seal 140 may be disposed adjacent to the spacer 130 at the lower end of the seal stack assembly 101. The third annular seal 140 may generally be oriented in the cavity 108 such that the jacket 141 is open outward towards the lower end of the seal stack assembly 101 and the base 142 of the jacket 141 is oriented adjacent to the spacer 130 and/or inward towards the upper end of the seal stack assembly 101. Additionally, the third annular seal 140 may generally be oriented in the cavity 108 such that the inner sealing leg 144 of the jacket 141 extends along and in contact with the shaft 104 and the outer sealing leg 116 of the jacket 141 extends along and in contact with the housing 102. In some embodiments, the seal stack assembly 101 may comprise a plurality of third seals 140. In such embodiments, each of the plurality of third annular seals 140 may be oriented in the same direction as disclosed herein.

FIG. 1B shows a partial cross-sectional view of an assembly 100 having an annular seal stack assembly 101 according to an embodiment of the disclosure. In some embodiments, the assembly 100 may include a seal stack assembly 101 with a second seal 120 and a third seal 140 only. The components of the assembly 100 may have all the same features of the components similarly referenced in FIG. 1A as described above. As shown in FIG. 1B, the second seal 120 may include a body 122, an inner sealing leg 123, and a sealing flange 124 extending at an angle from an end of the sealing leg 123. Further, the second seal 120 may include a sealing ring 126 disposed within a cavity 127 of the body 122 of the second seal 120. Further, the sealing ring 126 may comprise an energizing spring. In this embodiment, the second seal 120 forms an outer sealing leg on the outer diameter of the second annular seal 120, which partially forms the cavity 127.

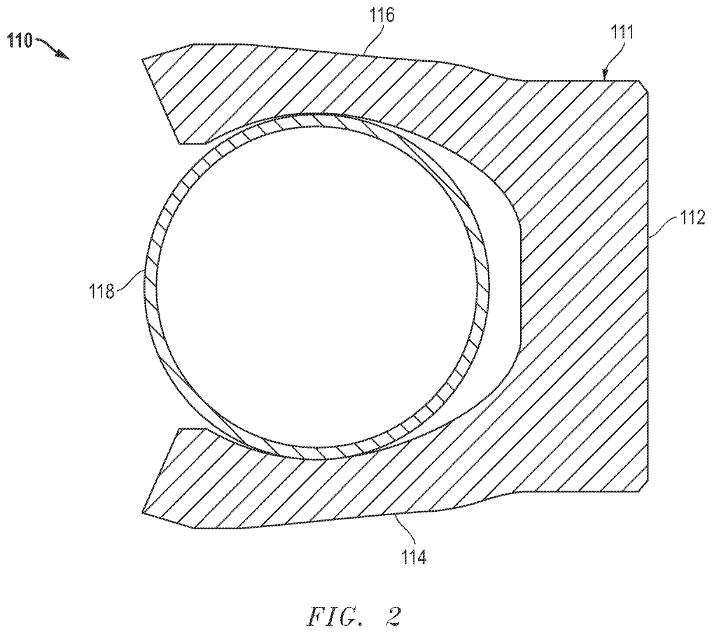

Further as shown in FIG. 1B, the seal stack assembly 101 may include a third seal 140. The third annular seal 140 may be disposed in the second portion 109 of the cavity 108 of the assembly 100. The third annular seal 140 may generally comprise a jacket 141 comprising a base 142, an inner sealing leg 144 extending from the base 142, and an outer sealing leg 146 extending from the base 142. The third annular seal 140 may also comprise an energizing spring 150. The energizing spring 150 may be disposed within the jacket 141 between and in contact with the inner sealing leg 144 of the jacket 141 and the support ring 148. In some embodiments, the energizing spring 150 may be elliptical or oval. However, in other embodiments, the energizing spring 150 may be round, U-shaped, or any other shape. The energizing spring 150 may be configured to bias the inner sealing leg 144 and the outer sealing leg 146 away from each other to maintain contact between the sealing legs 144, 146 of the third annular seal 140 and each of the housing 102 and the shaft 104 of the assembly 100. Further, the third annular seal 140 may also comprise a support ring 148 disposed within the jacket 141. In some embodiments, the support ring 148 may comprise a substantially L-shaped component, a substantially U-shaped component, a substantially rectangular component, or any other suitable shape. In some embodiments, the support ring 148 may be disposed in the jacket 141 such that the support ring 148 is in contact with the outer sealing leg 146 of the jacket 141. In some embodiments, the support ring 148 may be disposed in the jacket 141 such that the support ring 148 is in contact with the base 142 and the outer sealing leg 146 of the jacket 141. In other embodiments, the support ring 148 may be disposed in the jacket 141 such that the support ring 148 is in contact with the base 142, the inner sealing leg 144 of the jacket 141, and the outer sealing leg 146 of the jacket 141. In some embodiments, the outer sealing leg 146 may at least partially overlap the support ring 148 to retain the support ring 148 within the jacket 141. FIG. 2 shows a cross-sectional view of the first annular seal 110 according to an embodiment of the disclosure. The first annular seal 110 may generally comprise a jacket 111 comprising a base 112, an inner sealing leg 114 extending from the base 112, and an outer sealing leg 116 extending from the base 112. The first annular seal 110 may also comprise an energizing spring 118 disposed within the jacket 111 between and in contact with the inner sealing leg 114 and the outer sealing leg 116 of the jacket 111. In some embodiments, the inner sealing leg 114 and the outer sealing leg 116 may be substantially similar and/or symmetrical about a centerline of the base 112. Additionally, while not shown, the first annular seal 110 may also comprise a scraper 119.

In some embodiments, the jacket 111 may be formed from a thermoset, thermoplastic, or a combination thereof. More specifically, the jacket 111 may be formed from PTFE, a fluoropolymer, a perfluoropolymer, PTFE, TFM, PVF, PVDF, PCTFE, PFA, FEP, ETFE, ECTFE, PCTFE, a polyarylketone such as PEEK, PEK, or PEKK, a polysulfone such as PPS, PPSU, PSU, PPE, or PPO, aromatic polyamides such as PPA, thermoplastic polyimides such as PEI or TPI, or any combination thereof, either with or without reinforcing fillers.

In some embodiments, the energizing spring 118 may be formed from a resilient metallic material. More specifically, the energizing spring 118 may be formed from a nickel-chromium based alloy such as Inconel®, a nickel-based alloy, a cobalt-chromium-nickel-molybdenum alloy, a cobalt-chromium-nickel alloy such as Elgiloy®, nickel, titanium, tungsten, stainless steel, spring steel, steel, aluminum, zinc, copper, magnesium, tin, platinum, lead, iron, or bronze. In some embodiments, the energizing spring 118 may comprise a coating or plating, such as a gold plating, a silver plating, a nickel plating, an aluminum chromium nitride (AlCrN) plating, a titanium aluminum nitride (TiAlN) plating, any other wear resistant metallic plating, or any combination thereof.

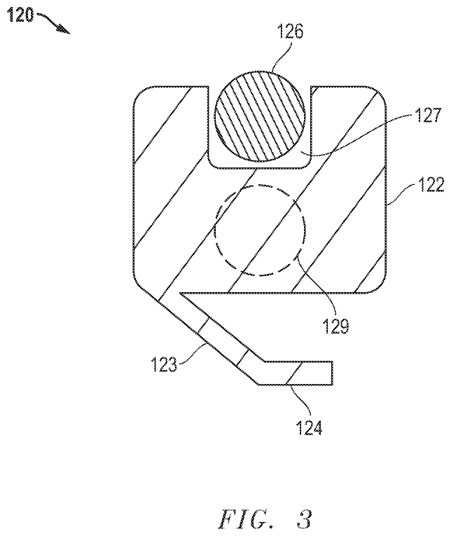

FIG. 3 shows a cross-sectional view of the second annular seal 120 according to an embodiment of the disclosure. The second annular seal 120 may generally comprise a body 122, an inner sealing leg 123 extending at an angle from the body 122, and a sealing flange 124 extending at an angle from an end of the inner sealing leg 123. The second annular seal 120 may also comprise and a sealing ring 126 disposed in a cavity 127 formed in the body 122 and on an opposing side of the body 122 from the sealing leg 123 and the sealing flange 124. In some embodiments, the sealing ring 126 may comprise an O-ring. However, in some embodiments, the sealing ring 126 may comprise an energizing spring. In some embodiments, the body 122 may comprise a substantially rectangular or square profile. Further, in some embodiments, the body 122 may comprise rounded or chamfered corners. In some embodiments, the second annular spring 120 may comprise an energizing spring disposed between the body 122 and the sealing leg 123 and/or the sealing flange 124. In some embodiments, the second annular seal 120 may comprise a metal band 129 disposed throughout the body 122. The metal band 129 may reduce the sensitivity of the second annular seal 120 to thermal contraction.

As stated, the inner sealing leg 123 may extend from the body 122 at an angle. In some embodiments, the inner sealing leg 123 may extend from the body 122 at an angle of at least 15 degrees, at least 30 degrees, at least 35 degrees, at least 40 degrees, at least 45 degrees, at least 50 degrees, at least 55 degrees, at least 60 degrees, at least 65 degrees, or at least 70 degrees. In some embodiments, the inner sealing leg 123 may extend from the body 122 at an angle of not greater than 90 degrees, not greater than 85 degrees, not greater than 80 degrees, not greater than 75 degrees, or not greater than 70 degrees. Further, it will be appreciated that the inner sealing leg 123 may extend from the body 122 at an angle of between any of these minimum and maximum values, such as at least 15 degrees to not greater than 90 degrees, or even at least 30 degrees to not greater than 60 degrees.

In some embodiments, the body 122, the inner sealing leg 123, and the sealing flange 124 (collectively main body portion) may generally be formed from a thermoset, thermoplastic, or a combination thereof. More specifically, the body 122, the inner sealing leg 123, and the sealing flange 124 (collectively main body portion) may be formed from PTFE, a fluoropolymer, a perfluoropolymer, PTFE, TFM, PVF, PVDF, PCTFE, PFA, FEP, ETFE, ECTFE, PCTFE, a polyarylketone such as PEEK, PEK, or PEKK, a polysulfone such as PPS, PPSU, PSU, PPE, or PPO, aromatic polyamides such as PPA, thermoplastic polyimides such as PEI or TPI, or any combination thereof, either with or without reinforcing fillers.

In some embodiments, the sealing ring 126 may be formed from an elastomeric material. In some embodiments, the sealing ring 126 may be formed from a resilient metallic material. More specifically, the sealing ring 126 may be formed from a nickel-chromium based alloy such as Inconel®, a nickel-based alloy, a cobalt-chromium-nickel-molybdenum alloy, a cobalt-chromium-nickel alloy such as Elgiloy®, nickel, titanium, tungsten, stainless steel, spring steel, steel, aluminum, zinc, copper, magnesium, tin, platinum, lead, iron, or bronze. In some embodiments, the sealing ring 126 may comprise a coating or plating, such as a gold plating, a silver plating, a nickel plating, an aluminum chromium nitride (AlCrN) plating, a titanium aluminum nitride (TiAlN) plating, any other wear resistant metallic plating, or any combination thereof.

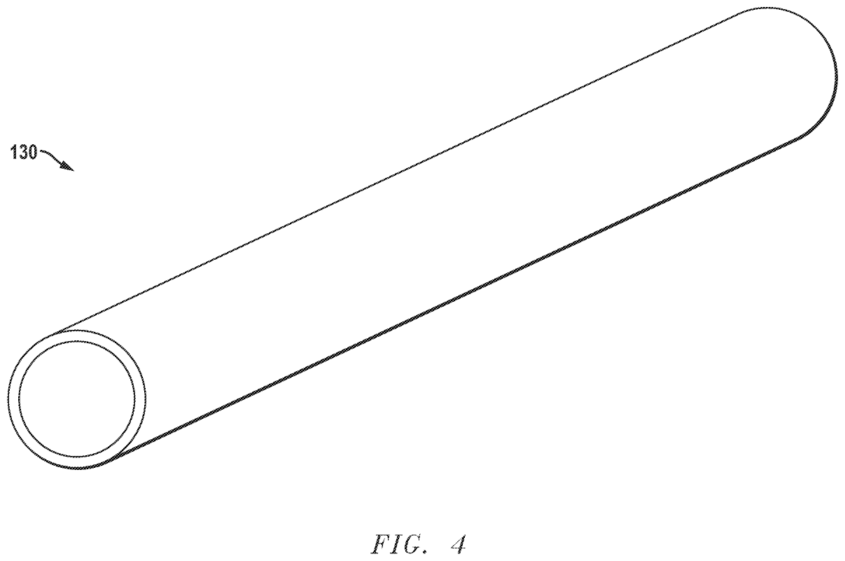

FIG. 4 shows an oblique view of the spacer 130 according to an embodiment of the disclosure. The spacer 130 may generally comprise a rigid hollow component having a substantially uniform inner diameter and a substantially uniform outer diameter. In some embodiments, the spacer 130 may be configured to cooperate with and/or support the first annular seal 110, the at least one second annular seal 120, and the third annular seal 140 to maintain an annular seal between the housing 102 and the shaft 104 of the assembly 100. In some embodiments, the spacer 130 may also distribute forces acting on one or more of the annular seals 110, 120, 140 to other annular seals 110, 120, 140 in the seal stack assembly 101 to maintain a pressure distribution across the seal stack assembly 101.

In some embodiments, the spacer 130 may be formed from a metallic material. More specifically, the spacer 130 may be formed from a nickel-chromium based alloy such as Inconel®, a nickel-based alloy, a cobalt-chromium-nickel-molybdenum alloy, a cobalt-chromium-nickel alloy such as Elgiloy®, nickel, titanium, tungsten, stainless steel, spring steel, steel, aluminum, zinc, copper, magnesium, tin, platinum, lead, iron, or bronze. In some embodiments, the spacer 130 may comprise a coating or plating. In some embodiments, the coating may be formed from PTFE, gold, silver, nickel, aluminum chromium nitride (AlCrN), titanium aluminum nitride (TiAlN), bronze, any other wear resistant metallic plating, any other soft metallic plating, or any combination thereof. The coating or plating may be configured to protect the spacer 130 from wear cause by relative movement of the shaft 104 with respect to the spacer 130.

In other embodiments, the spacer 130 may be formed from a thermoset, thermoplastic, or a combination thereof. More specifically, the spacer 130 may be formed from PTFE, a fluoropolymer, a perfluoropolymer, PTFE, TFM, PVF, PVDF, PCTFE, PFA, FEP, ETFE, ECTFE, PCTFE, a polyarylketone such as PEEK, PEK, or PEKK, a polysulfone such as PPS, PPSU, PSU, PPE, or PPO, aromatic polyamides such as PPA, thermoplastic polyimides such as PEI or TPI, or any combination thereof, either with or without reinforcing fillers.

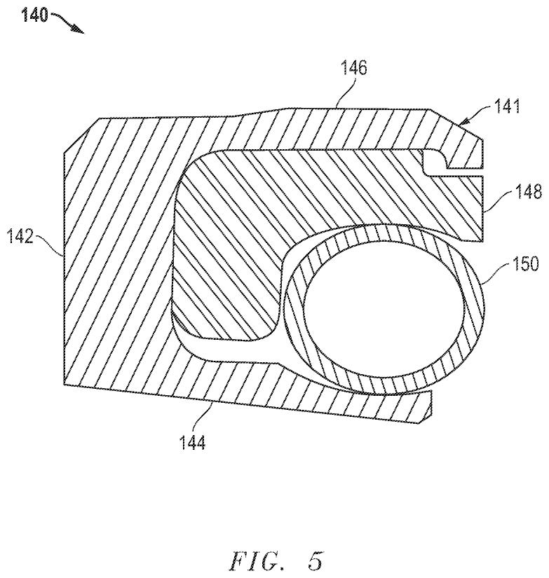

FIG. 5 shows a cross-sectional view of the third annular seal 140 according to an embodiment of the disclosure. The third annular seal 140 may generally comprise a jacket 141 comprising a base 142, an inner sealing leg 144 extending from the base 142, and an outer sealing leg 146 extending from the base 142. The third annular seal 140 may also comprise a support ring 148 disposed within the jacket 141. In some embodiments, the support ring 148 may comprise a substantially L-shaped component, a substantially U-shaped component, or any other suitable shape. In some embodiments, the support ring 148 may be disposed in the jacket 141 such that the support ring 148 is in contact with the outer sealing leg 146 of the jacket 141. In some embodiments, the support ring 148 may be disposed in the jacket 141 such that the support ring 148 is in contact with the base 142 and the outer sealing leg 146 of the jacket 141. In other embodiments, the support ring 148 may be disposed in the jacket 141 such that the support ring 148 is in contact with the base 142, the inner sealing leg 144 of the jacket 141, and the outer sealing leg 146 of the jacket 141. In some embodiments, the outer sealing leg 146 may at least partially overlap the support ring 148 to retain the support ring 148 within the jacket 141.

In some embodiments, the support ring 148 may provide additional support to the third annular seal 140 as compared to the first annular seal 110 and the second annular seal 120. In some embodiments, the support ring 148 may enable the third annular seal 140 to withstand more extreme temperatures and/or pressures as compared to the first annular seal 110 and the second annular seal 120. The third annular seal 140 may also comprise an energizing spring 150. The energizing spring 150 may be disposed within the jacket 141 between and in contact with the inner sealing leg 144 of the jacket 141 and the support ring 148. In some embodiments, the energizing spring 150 may be elliptical or oval. However, in other embodiments, the energizing spring 150 may be round, U-shaped, or any other shape. The energizing spring 150 may be configured to bias the inner sealing leg 144 and the outer sealing leg 146 away from each other to maintain contact between the sealing legs 144, 146 of the first annular seal 140 and each of the housing 102 and the shaft 104 of the assembly 100.

In some embodiments, the jacket 141 may generally be formed from a thermoset, thermoplastic, or a combination thereof. More specifically, the jacket 141 may be formed from PTFE, a fluoropolymer, a perfluoropolymer, PTFE, TFM, PVF, PVDF, PCTFE, PFA, FEP, ETFE, ECTFE, PCTFE, a polyarylketone such as PEEK, PEK, or PEKK, a polysulfone such as PPS, PPSU, PSU, PPE, or PPO, aromatic polyamides such as PPA, thermoplastic polyimides such as PEI or TPI, or any combination thereof, either with or without reinforcing fillers.

In some embodiments, the support ring 148 may generally be formed from a resilient metallic material. More specifically, the support ring 148 may be formed from a nickel-chromium based alloy such as Inconel®, a nickel-based alloy, a cobalt-chromium-nickel-molybdenum alloy, a cobalt-chromium-nickel alloy such as Elgiloy®, nickel, titanium, tungsten, stainless steel, spring steel, steel, aluminum, zinc, copper, magnesium, tin, platinum, lead, iron, or bronze. In some embodiments, the metallic support ring 148 may comprise a coating or plating, such as a gold plating, a silver plating, a nickel plating, an aluminum chromium nitride (AlCrN) plating, a titanium aluminum nitride (TiAlN) plating, any other wear resistant metallic plating, or any combination thereof.

In some embodiments, the energizing spring 150 may generally be formed from a resilient metallic material. More specifically, the energizing spring 150 may be formed from a nickel-chromium based alloy such as Inconel®, a nickel-based alloy, a cobalt-chromium-nickel-molybdenum alloy, a cobalt-chromium-nickel alloy such as Elgiloy®, nickel, titanium, tungsten, stainless steel, spring steel, steel, aluminum, zinc, copper, magnesium, tin, platinum, lead, iron, or bronze. In some embodiments, the energizing spring 150 may comprise a coating or plating, such as a gold plating, a silver plating, a nickel plating, an aluminum chromium nitride (AlCrN) plating, a titanium aluminum nitride (TiAlN) plating, any other wear resistant metallic plating, or any combination thereof.

FIG. 5 shows a flowchart of a method 500 of forming an annular seal in an assembly 100 according to an embodiment of the disclosure. The method 500 may begin at block 502 by providing an assembly 100 comprising a seal stack assembly 101 having a first annular seal 110, at least one second annular seal 120 disposed axially adjacent to the first annular seal 110, a spacer 130 disposed axially adjacent to the at least one second annular seal 120, and a third annular seal 140 disposed axially adjacent to the spacer 130. The method 500 may continue at block 504 by operating the assembly 100 at cryogenic temperatures, exposing at least a portion of the seal stack assembly 101 to cryogenic temperatures, or a combination thereof. The method 500 may continue at block 506 by continually providing an annular seal between a housing 102 and a shaft 104 of the assembly 100. In some embodiments, continually providing an annular seal between a housing 102 and a shaft 104 of the assembly 100 may occur simultaneously with operating the assembly 100 at cryogenic temperatures, exposing at least a portion of the seal stack assembly 101 to cryogenic temperatures, or a combination thereof. In some embodiments, continually providing an annular seal between a housing 102 and a shaft 104 of the assembly 100 may occur during relative motion between the shaft 104 and the seal stack assembly 101. In some embodiments, continually providing an annular seal between a housing 102 and a shaft 104 of the assembly 100 may occur during a change in pressure, a change in temperature, or a combination thereof. In some embodiments, the seal stack assembly 101 may be oriented in the assembly 100, such that the third annular seal 140 is subjected to the cryogenic temperatures.

Embodiments of the seal stack assembly 101 may comprise a total axial length suitable for a particular application. In some embodiments, the total axial length of the seal stack assembly 101 may be at least 25 mm, at least 50 mm, at least 75 mm, at least 100 mm, at least 125 mm, at least 150 mm, at least 175 mm, at least 200 mm, at least 225 mm, at least 250 mm, at least 275 mm, at least 300 mm, at least 325 mm, at least 350 mm, at least 375 mm, at least 400 mm, at least 425 mm, at least 450 mm, at least 475 mm, at least 500 mm, or at least 1000 mm.

Embodiments of the seal stack assembly 101 may comprise inner and outer diameters suitable for a particular application. In some embodiments, an inner diameter of the seal stack assembly 101 may be at least 1 mm, at least 2 mm, at least 3 mm, at least 4 mm, at least 5 mm, at least 6 mm, at least 7 mm, at least 8 mm, at least 9 mm, at least 10 mm, at least 25 mm, at least 50 mm, at least 75 mm, at least 100 mm, at least 150 mm, at least 200 mm, at least 250 mm, at least 300 mm, at least 500 mm, or even greater. In some embodiments, an outer diameter of the seal stack assembly 101 may be at least 1 mm, at least 2 mm, at least 3 mm, at least 4 mm, at least 5 mm, at least 6 mm, at least 7 mm, at least 8 mm, at least 9 mm, at least 10 mm, at least 11 mm, at least 12 mm, at least 13 mm, at least 14 mm, at least 15 mm, at least 25 mm, at least 50 mm, at least 75 mm, at least 100 mm, at least 150 mm, at least 200 mm, at least 250 mm, at least 300 mm, at least 500 mm, at least 1000 mm, or even greater.

Furthermore, it will be appreciated that the first annular seal 110, the second annular seal 120, and/or the third annular seal 140 may be interchangeable with other suitable annular seals. For example, in some embodiments, the first annular seal 110, the second annular seal 120, and/or the third annular seal 140 may be interchangeable. In some embodiments, the first annular seal 110, the second annular seal 120, and/or the third annular seal 140 may not be in the seal stack assembly 101. In some embodiments, the seal stack assembly 101 may not comprise a first annular seal 110 but may include a scraper 119. In some embodiments, the first annular seal 110 may be substantially similar, or even identical to the third annular seal 140. Accordingly, in some embodiments, the first annular seal 110 may be identical to the third annular seal 140 and may comprise a scraper 119 as disclosed herein. Furthermore, in some embodiments, the assembly 100 and/or the seal stack assembly 101 may comprise additional intervening annular seals between any of the first annular seal 110, the second annular seal 120 or plurality of second annular seals 120, the spacer 130, and/or the third annular seal 140.

Embodiments of an assembly 100, a seal stack assembly 101, and/or a method 600 of forming an annular seal in an assembly 100 may include one or more of the following:

### Embodiment 1

An annular seal stack assembly, comprising: a first annular seal; at least one second annular seal disposed axially adjacent to the first annular seal; a spacer disposed axially adjacent to the at least one second annular seal; and a third annular seal disposed axially adjacent to the spacer.

### Embodiment 2

An annular seal stack assembly, comprising: a first annular seal disposed at an upper end of the annular seal stack; at least one second annular seal disposed towards a lower end of the seal stack with respect to the first annular seal; a spacer disposed towards a lower end of the seal stack with respect to the at least one second annular seal; and a third annular seal disposed at the lower end of the seal stack assembly.

### Embodiment 3

The seal stack assembly of any of embodiments 1 to 2, wherein the seal stack assembly is configured to provide a seal between a housing and a shaft of an assembly.

### Embodiment 4

The seal stack assembly of embodiment 3, wherein a cavity is formed between the housing and the shaft of the assembly.

### Embodiment 5

An assembly, comprising: a housing; a shaft disposed within the housing; a cavity formed between the housing and the shaft; and an annular seal stack assembly disposed in the cavity and annularly about the shaft, wherein the annular seal stack is configured to provide a seal between the housing and the shaft, the seal stack assembly comprising: a first annular seal; at least one second annular seal disposed axially adjacent to the first annular seal; a spacer disposed axially adjacent to the at least one second annular seal; and a third annular seal disposed axially adjacent to the spacer.

### Embodiment 6

The seal stack assembly of embodiment 4 or the assembly of embodiment 5, wherein the cavity comprises a first portion and a second portion.

### Embodiment 7

The seal stack assembly or the assembly of embodiment 6, wherein the first portion comprises a larger outer diameter defined by the housing than the second portion.

### Embodiment 8

The seal stack assembly or the assembly of embodiment 6, wherein the first portion comprises a smaller outer diameter defined by the housing than the second portion.

### Embodiment 9

The seal stack assembly or the assembly of embodiment 6, wherein the first portion comprises a substantially similar or the same outer diameter defined by the housing than the second portion.

### Embodiment 10

The seal stack assembly or the assembly of any of the preceding embodiments, wherein the seal stack assembly comprises an upper end defined by the first annular seal and a lower end defined by the third annular seal.

### Embodiment 11

The seal stack assembly or the assembly of any of the preceding embodiments, wherein the first annular seal comprises: a jacket comprising a base, an inner sealing leg extending from the base, and an outer sealing leg extending from the base; and an energizing spring disposed within the jacket between and in contact with the inner sealing leg and the outer sealing leg of the jacket.

### Embodiment 12

The seal stack assembly or the assembly of embodiment 11, wherein the first annular seal comprises a scraper.

### Embodiment 13

The seal stack assembly or the assembly of embodiment 12, wherein the scraper is disposed adjacent to the base of the first annular seal.

### Embodiment 14

The seal stack assembly or the assembly of any of embodiments 12 to 13, wherein the scraper is configured to prevent or remove an accumulation of moisture, ice, or a combination thereof from the shaft of the assembly.

### Embodiment 15

The seal stack assembly or the assembly of any of embodiments 5 to 7, wherein the first annular seal is disposed in a first portion of the cavity of the assembly.

### Embodiment 16

The seal stack assembly or the assembly of any of embodiments 10 to 15, wherein the first annular seal is disposed at the upper end of the seal stack assembly.

### Embodiment 17

The seal stack assembly or the assembly of any of embodiments 11 to 16, wherein the first annular seal is oriented in the cavity such that the jacket is open outward towards the upper end of the seal stack assembly and the base of the jacket is oriented inward towards the lower end of the seal stack assembly.

### Embodiment 18

The seal stack assembly or the assembly of embodiment 17, wherein the first annular seal is oriented in the cavity such that the inner sealing leg of the jacket extends along and in contact with the shaft and the outer sealing leg of the jacket extends along and in contact with the housing.

### Embodiment 19

The seal stack assembly or the assembly of any of the preceding embodiments, wherein the seal stack assembly comprises a plurality of first annular seals.

### Embodiment 20

The seal stack assembly or the assembly of embodiment 19, wherein each of the plurality of first annular seals is oriented in the same direction.

### Embodiment 21

The seal stack assembly or the assembly of any of embodiments 11 to 20, wherein the jacket of the first annular seal is formed from a thermoset, thermoplastic, or a combination thereof.

### Embodiment 22

The seal stack assembly or the assembly of embodiment 21, wherein the jacket of the first annular seal is formed from PTFE, a fluoropolymer, a perfluoropolymer, PTFE, TFM, PVF, PVDF, PCTFE, PFA, FEP, ETFE, ECTFE, PCTFE, a polyarylketone such as PEEK, PEK, or PEKK, a polysulfone such as PPS, PPSU, PSU, PPE, or PPO, aromatic polyamides such as PPA, thermoplastic polyimides such as PEI or TPI, or any combination thereof, either with or without reinforcing fillers.

### Embodiment 23

The seal stack assembly or the assembly of any of embodiments 11 to 22, wherein the energizing spring is formed from a resilient metallic material.

### Embodiment 24

The seal stack assembly or the assembly of embodiment 23, wherein the energizing spring is formed from a nickel-chromium based alloy such as Inconel®, a nickel-based alloy, a cobalt-chromium-nickel-molybdenum alloy, a cobalt-chromium-nickel alloy such as Elgiloy®, nickel, titanium, tungsten, stainless steel, spring steel, steel, aluminum, zinc, copper, magnesium, tin, platinum, lead, iron, or bronze, with or without a coating.

### Embodiment 25

The seal stack assembly or the assembly of any of embodiments 2 to 24, wherein the first annular seal is configured to contact and provide an annular seal between a portion of the housing and a portion of the shaft of the assembly.

### Embodiment 26

The seal stack assembly or the assembly of any of the preceding embodiments, wherein the second annular seal is different from the first annular seal.

### Embodiment 27

The seal stack assembly or the assembly of any of the preceding embodiments, wherein the second annular seal comprises a body, an inner sealing leg extending at an angle from the body, a sealing flange extending at an angle from an end of the inner sealing leg, and a sealing ring disposed in a cavity formed in the body and on an opposing side of the body from the sealing leg and the sealing flange.

### Embodiment 28

The seal stack assembly or the assembly of embodiment 27, further comprising: an energizing spring disposed between the body and the sealing leg and/or the sealing flange.

### Embodiment 29

The seal stack assembly or the assembly of any of embodiments 27 to 28, wherein the body comprises a substantially rectangular or square profile.

### Embodiment 30

The seal stack assembly or the assembly of embodiment 29, wherein the body comprises rounded or chamfered corners.

### Embodiment 31

The seal stack assembly or the assembly of any of embodiments 6 to 30, wherein the second annular seal is disposed in the first portion of the cavity of the assembly.

### Embodiment 32

The seal stack assembly or the assembly of any of the preceding embodiments, wherein the second annular seal is disposed adjacent to the first annular seal.

### Embodiment 33

The seal stack assembly or the assembly of embodiment 32, wherein the second annular seal is disposed between the first annular seal and the spacer.

### Embodiment 34

The seal stack assembly or the assembly of any of embodiments 27 to 33, wherein the second annular seal is oriented in the cavity such that the inner sealing leg extends from the body inwardly at an angle towards the shaft and in the direction of the spacer.

### Embodiment 35

The seal stack assembly or the assembly of embodiment 34, wherein the second annular seal is oriented such that the sealing flange is in contact with the shaft.

### Embodiment 36

The seal stack assembly or the assembly of embodiment 35, wherein the sealing flange is substantially flat about a circumference or an outer diameter of the shaft.

### Embodiment 37

The seal stack assembly or the assembly of any of embodiments 27 to 36, wherein the second annular seal is oriented such that the sealing ring is in contact with and forms an annular seal with the housing of the assembly.

### Embodiment 38

The seal stack assembly or the assembly of embodiment 37, wherein the sealing ring comprises an O-ring, an energizing spring, or a spring energized seal.

### Embodiment 39

The seal stack assembly or the assembly of any of the preceding embodiments, wherein the seal stack assembly comprises a plurality of second annular seals.

### Embodiment 40

The seal stack assembly or the assembly of embodiment 39, wherein the seal stack assembly comprises two second annular seals.

### Embodiment 41

The seal stack assembly or the assembly of embodiment 39, wherein the seal stack assembly comprises more than two second annular seals.

### Embodiment 42

The seal stack assembly or the assembly of any of embodiments 39 to 41, wherein each of the plurality of second annular seals is oriented in the same direction.

### Embodiment 43

The seal stack assembly or the assembly of any of embodiments 39 to 42, wherein one or more of the plurality of second annular seals is free of the sealing ring.

### Embodiment 44

The seal stack assembly or the assembly of any of embodiments 27 to 43, wherein a main body portion comprising the body, the inner sealing leg, and the sealing flange of the second annular seal is formed from a thermoset, thermoplastic, or a combination thereof.

### Embodiment 45

The seal stack assembly or the assembly of embodiment 44, wherein the main body portion is formed from PTFE, a fluoropolymer, a perfluoropolymer, PTFE, TFM, PVF, PVDF, PCTFE, PFA, FEP, ETFE, ECTFE, PCTFE, a polyarylketone such as PEEK, PEK, or PEKK, a polysulfone such as PPS, PPSU, PSU, PPE, or PPO, aromatic polyamides such as PPA, thermoplastic polyimides such as PEI or TPI, or any combination thereof, either with or without reinforcing fillers.

### Embodiment 46

The seal stack assembly or the assembly of any of embodiments 27 to 45, wherein the sealing ring is formed from an elastomeric material.

### Embodiment 47

The seal stack assembly or the assembly of any of embodiments 27 to 45, wherein the sealing ring is formed from a resilient metallic material.

### Embodiment 48

The seal stack assembly or the assembly of embodiment 47, wherein the sealing ring is formed from a nickel-chromium based alloy such as Inconel®, a nickel-based alloy, a cobalt-chromium-nickel-molybdenum alloy, a cobalt-chromium-nickel alloy such as Elgiloy®, nickel, titanium, tungsten, stainless steel, spring steel, steel, aluminum, zinc, copper, magnesium, tin, platinum, lead, iron, or bronze.

### Embodiment 49

The seal stack assembly or the assembly of any of embodiments 2 to 48, wherein the second annular seal is configured to contact and provide an annular seal between a portion of the housing and a portion of the shaft of the assembly.

### Embodiment 50

The seal stack assembly or the assembly of any of the preceding embodiments, wherein the spacer comprises a rigid hollow component having a substantially uniform inner diameter and a substantially uniform outer diameter, a plurality of annular seals, other annular components, or a combination thereof.

### Embodiment 51

The seal stack assembly or the assembly of any of embodiment 6 to 50, wherein the spacer is disposed in the first portion of the cavity of the assembly.

### Embodiment 52

The seal stack assembly or the assembly of embodiment 51, wherein the spacer comprises a clearance fit within the first portion of the cavity of the assembly.

### Embodiment 53

The seal stack assembly or the assembly of any of the preceding embodiments, wherein the spacer is disposed adjacent to the second annular seal.

### Embodiment 54

The seal stack assembly or the assembly of embodiment 53, wherein the spacer is disposed between the second annular seal and the third annular seal.

### Embodiment 55

The seal stack assembly or the assembly of any of the preceding embodiments, wherein the spacer is a single unitary component.

### Embodiment 56

The seal stack assembly or the assembly of any of the preceding embodiments, wherein the spacer comprises at least 25%, at least 30%, at least 35%, at least 40%, at least 45%, at least 50%, at least 60%, at least 65%, or at least 75% of a total axial length of the seal stack assembly.

### Embodiment 57

The seal stack assembly or the assembly of embodiment 56, wherein the spacer comprises not greater than 95%, not greater than 90%, not greater than 85%, not greater than 80%, not greater than 75%, not greater than 70%, not greater than 65%, or not greater than 60% of the total axial length of the seal stack assembly.

### Embodiment 58

The seal stack assembly or the assembly of any of the preceding embodiments, wherein the spacer is formed from a metallic material.

### Embodiment 59

The seal stack assembly or the assembly of embodiment 58, wherein the spacer is formed from a nickel-chromium based alloy such as Inconel®, a nickel-based alloy, a cobalt-chromium-nickel-molybdenum alloy, a cobalt-chromium-nickel alloy such as Elgiloy®, nickel, titanium, tungsten, stainless steel, spring steel, steel, aluminum, zinc, copper, magnesium, tin, platinum, lead, iron, or bronze.

### Embodiment 60

The seal stack assembly or the assembly of embodiment 59, wherein the spacer comprises a coating.

### Embodiment 61

The seal stack assembly or the assembly of embodiment 60, wherein the coating is formed from PTFE, bronze, silver, gold, nickel, aluminum chromium nitride (AlCrN), titanium aluminum nitride (TiAlN), any other wear resistant metallic plating, any other soft metallic plating, or any combination thereof.

### Embodiment 62

The seal stack assembly or the assembly of any of embodiments 2 to 61, wherein the spacer is configured to support the first annular seal, the second annular seal, and the third annular seal to maintain an annular seal between the housing and the shaft of the assembly.

### Embodiment 63

The seal stack assembly or the assembly of any of the preceding embodiments, wherein the third annular seal is different from the first annular seal.

### Embodiment 64

The seal stack assembly or the assembly of any of the preceding embodiments, wherein the third annular seal is different from the second annular seal.

### Embodiment 65

The seal stack assembly or the assembly of any of the preceding embodiments, wherein the third annular seal comprises: a jacket comprising a base, an inner sealing leg extending from the base, and an outer sealing leg extending from the base; a support ring disposed within the jacket; and an energizing spring disposed between and in contact with the inner sealing leg of the jacket and the support ring.

### Embodiment 66

The seal stack assembly or the assembly of embodiment 65, wherein the support ring comprises a substantially L-shaped, a substantially U-shaped, or a substantially rectangular component.

### Embodiment 67

The seal stack assembly or the assembly of any of embodiments 65 to 66, wherein the support ring is disposed in the jacket such that the support ring is in contact with the base, the inner sealing leg of the jacket, the outer sealing leg of the jacket, or a combination thereof.

### Embodiment 68

The seal stack assembly or the assembly of any of embodiments 65 to 67, wherein the support ring provides additional support to the third annular seal as compared to the first annular seal and the second annular seal and enables the third annular seal to withstand more extreme temperatures and/or pressures as compared to the first annular seal and the second annular seal.

### Embodiment 69

The seal stack assembly or the assembly of any of embodiments 11 to 68, wherein the energizing spring of the first annular seal and the energizing spring of the second annular seal are elliptical, oval, round, or U-shaped.

### Embodiment 70

The seal stack assembly or the assembly of any of embodiments 6 to 69, wherein the third annular seal is disposed in the second portion of the cavity of the assembly.

### Embodiment 71

The seal stack assembly or the assembly of embodiment 70, wherein the third annular seal comprises a smaller outer diameter than an outer diameter of the first annular seal, the second annular seal, and/or the spacer.

### Embodiment 72

The seal stack assembly or the assembly of embodiment 71, wherein the outer diameter of the third annular seal is at least 1%, at least 2%, at least 3%, at least 4%, at least 5%, at least 10%, at least 15%, at least 20%, or at least 25% smaller than the outer diameter of the first annular seal, the second annular seal, and/or the spacer.

### Embodiment 73

The seal stack assembly or the assembly of embodiment 72, wherein the outer diameter of the third annular seal is not greater than 50%, not greater than 45%, not greater than 40%, not greater than 35%, not greater than 30%, or not greater than 25% smaller than the outer diameter of the first annular seal, the second annular seal, and/or the spacer.

### Embodiment 74

The seal stack assembly or the assembly of embodiment 70, wherein the third annular seal comprises a larger outer diameter than an outer diameter of the first annular seal, the second annular seal, and/or the spacer.

### Embodiment 75

The seal stack assembly or the assembly of embodiment 74, wherein the outer diameter of the third annular seal is at least 1%, at least 2%, at least 3%, at least 4%, at least 5%, at least 10%, at least 15%, at least 20%, or at least 25% larger than the outer diameter of the first annular seal, the second annular seal, and/or the spacer.

### Embodiment 76

The seal stack assembly or the assembly of embodiment 75, wherein the outer diameter of the third annular seal is not greater than 50%, not greater than 45%, not greater than 40%, not greater than 35%, not greater than 30%, or not greater than 25% larger than the outer diameter of the first annular seal, the second annular seal, and/or the spacer.

### Embodiment 77

The seal stack assembly or the assembly of embodiment 70, wherein the third annular seal comprises a substantially similar or the same outer diameter as an outer diameter of the first annular seal, the second annular seal, and/or the spacer.

### Embodiment 78

The seal stack assembly or the assembly of any of embodiments 11 to 77, wherein the third annular seal is disposed adjacent to the spacer at the lower end of the seal stack assembly.

### Embodiment 79

The seal stack assembly or the assembly of any of embodiments 63 to 78, wherein the third annular seal is oriented in the cavity such that the jacket is open outward towards the lower end of the seal stack assembly and the base of the jacket is oriented adjacent to the spacer and/or inward towards the upper end of the seal stack assembly.

### Embodiment 80

The seal stack assembly or the assembly of embodiment 79, wherein the third annular seal is oriented in the cavity such that the inner sealing leg of the jacket extends along and in contact with the shaft and the outer sealing leg of the jacket extends along and in contact with the housing.

### Embodiment 81

The seal stack assembly or the assembly of any of the preceding embodiments, wherein the seal stack assembly comprises a plurality of third seals.

### Embodiment 82

The seal stack assembly or the assembly of embodiment 81, wherein each of the plurality of third annular seals is oriented in the same direction.

### Embodiment 83

The seal stack assembly or the assembly of any of embodiments 11 to 82, wherein the jacket of the third annular seal is formed from a thermoset, thermoplastic, or a combination thereof.

### Embodiment 84

The seal stack assembly or the assembly of embodiment 83, wherein the jacket of the third annular seal is formed from PTFE, a fluoropolymer, a perfluoropolymer, PTFE, TFM, PVF, PVDF, PCTFE, PFA, FEP, ETFE, ECTFE, PCTFE, a polyarylketone such as PEEK, PEK, or PEKK, a polysulfone such as PPS, PPSU, PSU, PPE, or PPO, aromatic polyamides such as PPA, thermoplastic polyimides such as PEI or TPI, or any combination thereof, either with or without reinforcing fillers.

### Embodiment 85

The seal stack assembly or the assembly of any of embodiments 11 to 84, wherein the energizing spring is formed from a resilient metallic material.

### Embodiment 86

The seal stack assembly or the assembly of embodiment 85, wherein the energizing spring is formed from a nickel-chromium based alloy such as Inconel®, a nickel-based alloy, a cobalt-chromium-nickel-molybdenum alloy, a cobalt-chromium-nickel alloy such as Elgiloy®, nickel, titanium, tungsten, stainless steel, spring steel, steel, aluminum, zinc, copper, magnesium, tin, platinum, lead, iron, or bronze, with or without a coating.

### Embodiment 87

The seal stack assembly or the assembly of any of embodiments 2 to 86, wherein the third annular seal is configured to contact and provide an annular seal between a portion of the housing and a portion of the shaft of the assembly.

### Embodiment 88

The seal stack assembly or the assembly of any of embodiments 2 to 87, wherein the seal stack assembly is suitable for operation between room temperature (at least about 15 degrees Celsius) and cryogenic temperatures (at least about −150 degrees Celsius, or even at least about −270 degrees Celsius), at elevated pressures (at least up to 24 bar (about 350 psi) or greater), or a combination thereof, to continually provide an annular seal between the housing and the shaft of the assembly.

### Embodiment 89

The seal stack assembly or the assembly of any of embodiments 2 to 88, wherein the seal stack assembly is configured to continually provide an annular seal between the housing and the shaft of the assembly during operation of the assembly at cryogenic temperatures, during exposure of at least a portion of the seal stack assembly to cryogenic temperatures, or a combination thereof.

### Embodiment 90

The seal stack assembly or the assembly of any of embodiments 2 to 89, wherein the seal stack assembly is configured to continually provide an annular seal between the housing and the shaft of the assembly during a change in pressure, a change in temperature, or a combination thereof.

### Embodiment 91

The seal stack assembly or the assembly of any of embodiments 2 to 90, wherein the assembly comprises a cryogenic reciprocating application.

### Embodiment 92

The seal stack assembly or the assembly of any of embodiments 2 to 91, wherein the assembly comprises a pump.

### Embodiment 93

The seal stack assembly or the assembly of embodiment 92, wherein the assembly comprises a reciprocating pump.

### Embodiment 94

The seal stack assembly or the assembly of embodiment 93, wherein the assembly comprises a cryogenic reciprocating pump.

### Embodiment 95

The seal stack assembly or the assembly of embodiment 94, wherein the assembly comprises a liquid hydrogen (LH2) reciprocating pump.

### Embodiment 96

The seal stack assembly or the assembly of embodiment 95, wherein the seal stack assembly is disposed in a low pressure side of the liquid hydrogen (LH2) reciprocating pump.

### Embodiment 97

A method of forming an annular seal in an assembly, comprising: providing an assembly comprising a seal stack assembly having a first annular seal, at least one second annular seal and disposed axially adjacent to the first annular seal, a spacer disposed axially adjacent to the at least one second annular seal, and a third annular seal disposed axially adjacent to the spacer; operating the assembly at cryogenic temperatures, exposing at least a portion of the seal stack assembly to cryogenic temperatures, or a combination thereof; and continually providing an annular seal between a housing and a shaft of the assembly.

### Embodiment 98

The method of embodiment 97, wherein continually providing an annular seal between the housing and the shaft of the assembly occurs during relative motion between the shaft and the seal stack assembly.

### Embodiment 99

The method of any of embodiments 97 to 98, wherein continually providing an annular seal between the housing and the shaft of the assembly occurs simultaneously with operating the assembly at cryogenic temperatures, exposing at least a portion of the seal stack assembly to cryogenic temperatures, or a combination thereof.

### Embodiment 100

The method of any of embodiments 97 to 99, wherein continually providing the annular seal between the housing and the shaft of the assembly occurs during a change in pressure, a change in temperature, or a combination thereof.

### Embodiment 101

The method of any of embodiments 97 to 100, wherein the assembly comprises a cryogenic reciprocating application.

### Embodiment 102

The method of any of embodiments 97 to 101, wherein the assembly comprises a pump.

### Embodiment 103

The method of embodiment 102, wherein the assembly comprises a reciprocating pump.

### Embodiment 104

The method of embodiment 103, wherein the assembly comprises a cryogenic reciprocating pump.

### Embodiment 105

The method of embodiment 104, wherein the assembly comprises a liquid hydrogen (LH2) reciprocating pump.

### Embodiment 106

The method of embodiment 105, wherein the seal stack assembly is disposed in a low pressure side of the liquid hydrogen (LH2) reciprocating pump.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. An annular seal stack assembly, comprising:
at least one second annular seal;
a spacer disposed axially adjacent to the at least one second annular seal; and
a third annular seal disposed axially adjacent to the spacer.

2. An annular seal stack assembly, comprising:
at least one second annular seal disposed towards a lower end of the seal stack;
a spacer disposed towards a lower end of the seal stack with respect to the at least one second annular seal; and
a third annular seal disposed at the lower end of the seal stack assembly.

3. The seal stack assembly of claim 1, wherein the seal stack assembly is configured to provide a seal between a housing and a shaft of an assembly.

4. The seal stack assembly of claim 3, wherein a cavity is formed between the housing and the shaft of the assembly.

5. An assembly, comprising:
a housing;
a shaft disposed within the housing;
a cavity formed between the housing and the shaft; and
an annular seal stack assembly disposed in the cavity and annularly about the shaft, wherein the annular seal stack is configured to provide a seal between the housing and the shaft, the seal stack assembly comprising:
at least one second annular seal;
a spacer disposed axially adjacent to the at least one second annular seal; and
a third annular seal disposed axially adjacent to the spacer.

6. The assembly of claim 5, wherein the cavity comprises a first portion and a second portion.

7. The seal stack assembly of claim 1, wherein the second annular seal comprises a body, an inner sealing leg extending at an angle from the body, a sealing flange extending at an angle from an end of the inner sealing leg, and a sealing ring disposed in a cavity formed in the body and on an opposing side of the body from the sealing leg and the sealing flange.

8. The seal stack assembly of claim 7, further comprising: an energizing spring disposed between the body and the sealing leg and/or the sealing flange.

9. The seal stack assembly of claim 1, wherein the second annular seal is disposed in the first portion of the cavity of the assembly.

10. The seal stack assembly of claim 1, wherein the second annular seal is oriented in the cavity such that the inner sealing leg extends from the body inwardly at an angle towards the shaft and in the direction of the spacer.

11. The seal stack assembly of claim 10, wherein the second annular seal is oriented such that the sealing flange is in contact with the shaft.

12. The seal stack assembly of claim 11, wherein the sealing flange is substantially flat about a circumference or an outer diameter of the shaft.

13. The seal stack assembly of claim 12, wherein the second annular seal is oriented such that the sealing ring is in contact with and forms an annular seal with the housing of the assembly.

14. The seal stack assembly of claim 13, wherein the sealing ring comprises an O-ring, an energizing spring, or a spring energized seal.

15. The seal stack assembly of claim 1, wherein the seal stack assembly comprises a plurality of second annular seals.

16. The seal stack assembly of claim 1, wherein the second annular seal comprises a main body portion comprising the body, the inner sealing leg, and the sealing flange of the second annular seal is formed from a thermoset, thermoplastic, or a combination thereof.

17. The seal stack assembly of claim 1, wherein the spacer comprises a rigid hollow component having a substantially uniform inner diameter and a substantially uniform outer diameter, a plurality of annular seals, other annular components, or a combination thereof.

18. The seal stack assembly of claim 1, wherein the third annular seal comprises:
a jacket comprising a base, an inner sealing leg extending from the base, and an outer sealing leg extending from the base;
a support ring disposed within the jacket; and
an energizing spring disposed between and in contact with the inner sealing leg of the jacket and the support ring.

19. The seal stack assembly of claim 18, wherein the support ring comprises a substantially L-shaped, a substantially U-shaped, or a substantially rectangular component.

20. The seal stack assembly of claim 19, wherein the support ring is disposed in the jacket such that the support ring is in contact with the base, the inner sealing leg of the jacket, the outer sealing leg of the jacket, or a combination thereof.
